(19) United States
(12) Patent Application Publication
(10) Pub. No.: US 2014/0228101 A1
(43) Pub. Date: Aug. 14, 2014

(54) SYSTEMS, APPARATUS AND METHODS FOR PROVIDING GAMING APPLICATIONS

(71) Applicant: IGT, Las Vegas, NV (US)

(72) Inventor: Anthony J. Baerlocher, Reno, NV (US)

(73) Assignee: IGT, Las Vegas, NV (US)

(21) Appl. No.: 14/253,499

(22) Filed: Apr. 15, 2014

Related U.S. Application Data
(63) Continuation of application No. 12/769,548, filed on Apr. 28, 2010, now abandoned.

(51) Int. Cl. G07F 17/32

(52) U.S. Cl. CPC G07F 17/3255
USPC 463/25

(57) ABSTRACT

A player may directly license wager gaming software from a game provider, such as a gaming manufacturer. The player may, for example, be able to directly license a software application and/or a game theme at a specified gaming manufacturer's website. The player may be required to be a member of the gaming manufacturer's player loyalty account in order to directly license such software. The gaming manufacturer may enable access to the game of chance at one or more regulated locations, such as participating casinos that use a server-based gaming system provided by the gaming manufacturer. The casino and/or the player may receive financial credits, rebates, etc., if the player uses the licensed gaming software at the casino.

### CROSS-REFERENCE TO RELATED PATENT APPLICATIONS

This application is a continuation of U.S. patent application Ser. No. 12/769,548, entitled “SYSTEMS, APPARATUS AND METHODS FOR PROVIDING GAMING APPLICATIONS,” filed on Apr. 28, 2010, which is incorporated herein by reference in its entirety and for all purposes.

### FIELD

The present invention relates generally to methods and devices for providing games, such as wagering games.

### BACKGROUND

Wager gaming is a multi-billion dollar industry. Providing new and exciting wagering games, including but not limited to wagering games presented on wager gaming machines, is an important part of maintaining player interest and casino revenues. However, it can be very challenging for game providers (also referred to herein as “gaming manufacturers”) to make a substantial profit by providing new wagering games. In the past, wagering game themes were specific to a particular design of wager gaming machine. Bundling software and hardware in a wager gaming machine provides the potential of higher initial revenue for gaming manufacturers, but involves various potential drawbacks to both casinos and gaming manufacturers.

Some game themes, such as IGT's “Wheel of Fortune™” game theme, are still provided on a customized design of wager gaming machine that includes characteristic peripheral devices and/or other distinctive features (such as the wheel) associated with that game theme. However, current trends involve a shift to a software-based model, wherein many game themes may be downloaded to the same general type of wager gaming machine. Game providers may, for example, provide casinos with access to a library of downloadable wagering game software. Such systems (sometimes referred to herein as server-based or “sb” systems) provide great flexibility and a very wide variety of available wagering games for casino patrons. Although current server-based gaming machines and systems are satisfactory, it would be desirable to provide improved devices, methods and systems for providing gaming applications.

### SUMMARY

New methods and systems for providing game themes are described herein. According to some implementations, wagering games may be licensed directly to a player. Therefore, the risk and financial burden of licensing new game themes may be borne partially (or entirely) by people or entities other than casinos. In some such implementations, the player may choose from various wagering game themes on a website, which may be provided by the gaming manufacturer. Selected games may be licensed directly to the player and may be associated with the gaming manufacturer's player loyalty account. Some game themes and/or versions of game themes may be available only via direct licensing to the player via a wide area network such as the Internet and/or via a local network. The local network may be a casino-based network such as IGT's Advantage® System.

The player may be able to access and play such games at a wager gaming machine in a participating casino. The game provider may provide to the player (and/or to the participating casino) a financial incentive for using games licensed to the player. For example, if the player plays the game at a participating casino, a credit or other benefit may be provided to the casino by the gaming manufacturer.

In some such implementations, if the player is offered a financial incentive (such as match play or free play) for playing the game, the gaming manufacturer may provide a corresponding financial credit for this financial incentive to the casino. In some examples of match play, when a player wagers an amount, a gaming machine or a gaming system may place an equal wager on the player's behalf, effectively doubling the wager amount and the potential payout for a winning outcome. In other examples of match play, when a player wagers an amount on a first game, a second game may be provided at the same wager level for no additional charge. The extent of match play may be limited according to a predetermined maximum match play credit, limited by time or by gaming session (e.g., limited to a first gaming session) and/or limited in some other fashion. Alternatively, or additionally, the gaming manufacturer may provide the financial credit in the form of a reduction in MegaJackpot™ fees, a deduction from the fees for providing an sb system to the casino, free advertising on the manufacturer website, special promotions for preferred customers, exclusive offers, direct monetary payment or a combination thereof.

Some embodiments described herein provide a system that includes a web server, a verification server and a licensing server. The web server may be configured to host a website featuring wagering games available for players to license directly from a game provider to the player. The wagering games may, for example, be configured for play on authorized wager gaming machines in one or more participating gaming establishments. The web server may be further configured to receive player input regarding selected wagering games and to receive player information and payment information from the player.

The verification server may be configured to receive player information and wagering game information via the web server. The verification server may be further configured to determine whether the player is eligible to play a version of the wagering game in at least one participating gaming establishment. The licensing server may be configured to arrange licensing of the wagering game directly from a game provider to the player upon receiving an indication from the verification server that the player is eligible to play the wagering game.

The validation server may be further configured to receive an indication from a wager gaming machine of a participating gaming establishment that a player wishes to commence an initial gaming session with a licensed wagering game. The validation server may be further configured to verify whether the player is eligible to play any version of the wagering game at the participating gaming establishment. If the validation server verifies that the player is eligible, the validation server may be further configured to send an authorization to the gaming establishment authorizing the player to play the wagering game.

The system may further comprise a wagering game downloading server. The validation server may be further configured to send a download authorization to the wagering game downloading server if the validation server verifies that the player is eligible. The validation server may be further configured to determine a compliant version of the wagering game that is in compliance with the jurisdictional requirements applicable to the participating gaming establishment. The download authorization may authorize a download of the compliant version of the wagering game to the participating gaming establishment.

The system may further comprise a wagering game library comprising storage media having wagering games stored thereon. The wagering game downloading server may be configured to select the compliant version of the wagering game from the wagering game library and to download the compliant version of the wagering game to a device of the participating gaming establishment. In some such embodiments, the device of the participating gaming establishment may comprise a local server of the participating gaming establishment that is configured to receive the downloaded compliant version of the wagering game and to download the compliant version of the wagering game to the wager gaming machine.

At least one device of the system may be further configured to receive an indication from a wager gaming machine of a participating gaming establishment that a player wishes to commence an initial gaming session with a licensed wagering game and, responsive to the indication, authorize a monetary credit to the gaming establishment. At least one device of the system may be further configured to receive an indication from a wager gaming machine of a participating gaming establishment that a player wishes to commence an initial gaming session with a licensed wagering game and, responsive to the indication, authorize the gaming establishment to provide free play or match play to the player.

Some methods described herein may involve providing (e.g., via a web server), wagering games on a website. The wagering games may, for example, be configured for play on authorized wager gaming machines in a gaming establishment. Such methods may involve receiving (e.g., at the web server), a player selection of a wagering game, verifying that a player is eligible to play the wagering game, receiving payment from the player and licensing the wagering game directly from a game provider to the player.

Such methods may also involve the following procedures: receiving an indication from an authorized wager gaming machine of a gaming establishment that the player wishes to commence an initial gaming session with the licensed wagering game; verifying that the player is eligible to play the wagering game at the gaming establishment; sending an authorization to the gaming establishment for the player to play the wagering game; authorizing a download of the wagering game to the gaming establishment; and providing a monetary credit to the gaming establishment. Such methods may also comprise authorizing free play or match play for the player.

Alternative methods are also provided herein. Some such methods may involve the following procedures: receiving an indication from an authorized wager gaming machine of a gaming establishment that a player wishes to commence an initial gaming session with a wagering game; verifying that the player is eligible to play the wagering game at the gaming establishment and that the wagering game is licensed directly to the player; sending an authorization to the gaming establishment for the player to play the wagering game; authorizing a download of the wagering game to the gaming establishment; and authorizing a monetary credit to be provided to the gaming establishment.

Some apparatus described herein may include a network interface and a logic system. The logic system may include one or more processors, programmable logic devices, etc. The logic system may be configured to do the following: receive, via the network interface, an indication from an authorized wager gaming machine of a gaming establishment that a player wishes to commence an initial gaming session with a wagering game; verify that the player is eligible to play the wagering game at the gaming establishment and that the wagering game is licensed directly to the player; send, via the network interface, an authorization to the gaming establishment for the player to play the wagering game; authorize a download of the wagering game to the gaming establishment; and authorize a monetary credit to be provided to the gaming establishment.

These and other methods of the invention may be implemented by various types of hardware, software, firmware, etc. For example, some features of the invention may be implemented, at least in part, by machine-readable media that include program instructions, state information, etc., for performing various operations described herein. Examples of program instructions include both machine code, such as produced by a compiler, and files containing higher-level code that may be executed by the computer using an interpreter. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

### BRIEF DESCRIPTION OF THE FIGURES

FIG. 1 depicts devices that may be used to implement some methods described herein.

FIG. 2 is a flow chart that outlines steps of some methods described herein.

FIGS. 3A through 3H are examples of screen layouts that may be presented by a web server hosting a website according to some methods described herein.

FIG. 4 is a flow chart that outlines steps of some methods described herein.

FIG. 5 depicts devices of gaming establishments and a central system that may be used for some implementations described herein.

FIG. 6 is a flow chart that outlines steps of other methods described herein.

FIG. 7 depicts a gaming machine.

FIG. 8 depicts a network device that may be used for some implementations described herein.

### DETAILED DESCRIPTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. For example, the steps of methods shown and described herein are not necessarily performed in the order indicated. It should also be understood that the methods of the invention may include more or fewer steps than are indicated.

Device functionality may be apportioned by grouping or dividing tasks in any convenient fashion. Therefore, when steps are described herein as being performed by a single device, the steps may alternatively be performed by multiple devices and vice versa.

The gaming industry is in the process of shifting to a software-based model, in which many game themes may be downloaded to the same general type of wager gaming machine. Casinos that implement such sb systems are provided with various advantages over previous implementations of “stand alone” wager gaming machines. For example, denominations, game themes and other features may be changed to accommodate the changing demographics of casino patrons at different times of the day, different days of the week, etc. Moreover, casinos can provide casino patrons with access to a very wide variety of available wagering games.

However, the current situation is not optimal. For example, some pricing issues may be associated with current sb systems. Normally, all game themes in a “library” are made available to the casino at a common price regardless of their popularity with casino patrons. Casino owners may believe that this pricing model is unfair if they are paying for a library that includes unused or little-used game themes.

The absence of a link between cost and performance may also create barriers to new game development. If game providers are not rewarded for performance, revenues may be hard to grow. Further, when a large library is licensed frequent software updates may be required. The associated processes can be time-consuming for the game provider and also may place demands upon the casino's network bandwidth. A substantial portion of these efforts may be directed to little-used game themes.

The present application describes methods and systems that allow a gaming manufacturer to provide a casino with a library of gaming applications without requiring the casino to purchase or license all of the game themes in the library. The gaming manufacturer may, for example, be able to sell the casino a wager gaming machine (also referred to herein as an electronic gaming machine or “EGM”) that is configured to work with the gaming manufacturer's game server and other components of a server-based system. New game themes (also referred to herein as “games”) and applications may be provided at a nominal cost or, in some implementations, at no cost to the casino. Periodic upgrades may also be provided at a nominal cost or at no cost to the casino.

According to some such implementations, the reduction in cost to the casino will result from a more direct relationship between gaming manufacturers and players. For example, a player may be required to “purchase” or directly license wager gaming software from the gaming manufacturer. The player may, for example, be able to directly license a software application and/or a game theme at a first secured location. The gaming manufacturer may enable access to the game of chance at one or more second regulated locations. The second locations may be EGMs provided by the gaming manufacturer and made available at a casino as part of a server-based gaming system. In some such embodiments, the first secured location may be provided via the Internet at a specified gaming manufacturer website, such as a website where the player has an account with a player loyalty program of the gaming manufacturer.

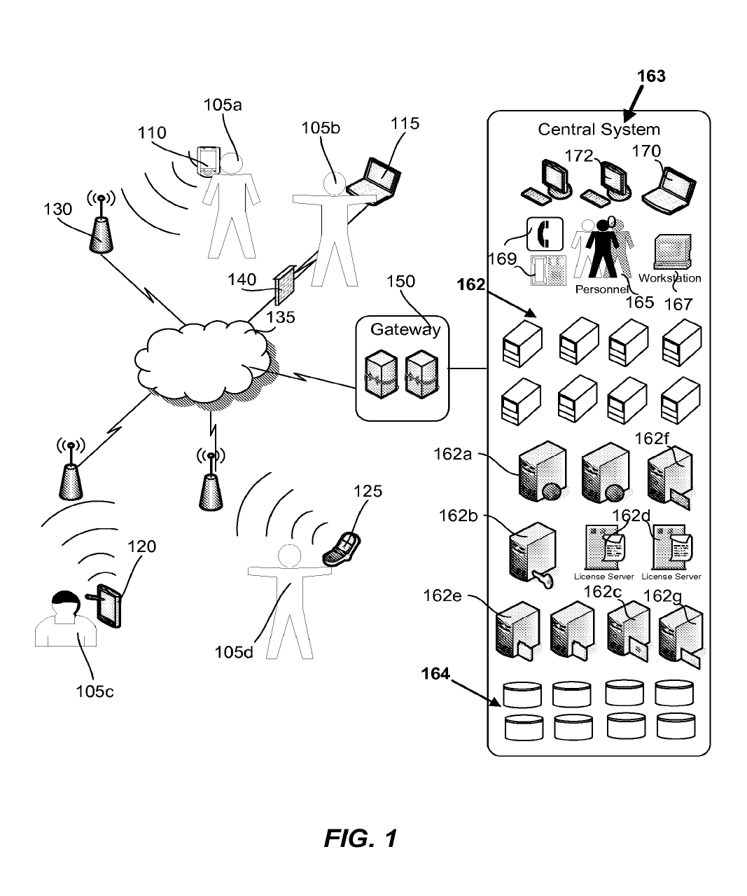

Functionality related to the present invention may be provided, at least in part, by devices such as those depicted in FIG. 1. The devices and configurations shown in FIG. 1, as in other figures shown and described herein, are merely made by way of illustration and example. Many other devices and configurations may be used to implement features of the present invention. Here, players 105 may use a variety of devices to access such a website. Player 105a is using smart phone 110. Player 105b may access the website using laptop 115. Player 105c may use tablet device 120 and player 105d may use cellular telephone 125. Wireless access points 130 provide access to the Internet 135 for wireless devices. Player 105b is located in a home network that includes firewall 140 and other features. Other switches, routers, etc., may be involved in establishing and/or maintaining such communications, but such devices are not illustrated in FIG. 1.

Here, gateway 150 controls communications between the Internet 135 and central system 163. In this example, central system 163 is operated under the control of a gaming manufacturer such as IGT™, the current assignee.

Central system 163 includes various types of servers 162 to accomplish some of the tasks described herein. For ease of illustration, these servers are depicted as separate devices according to their function. In some embodiments, separate servers may be configured in this manner. However, in some embodiments, an individual server may provide more than one general type of functionality. For example, different blades of the same blade server may provide different functions.

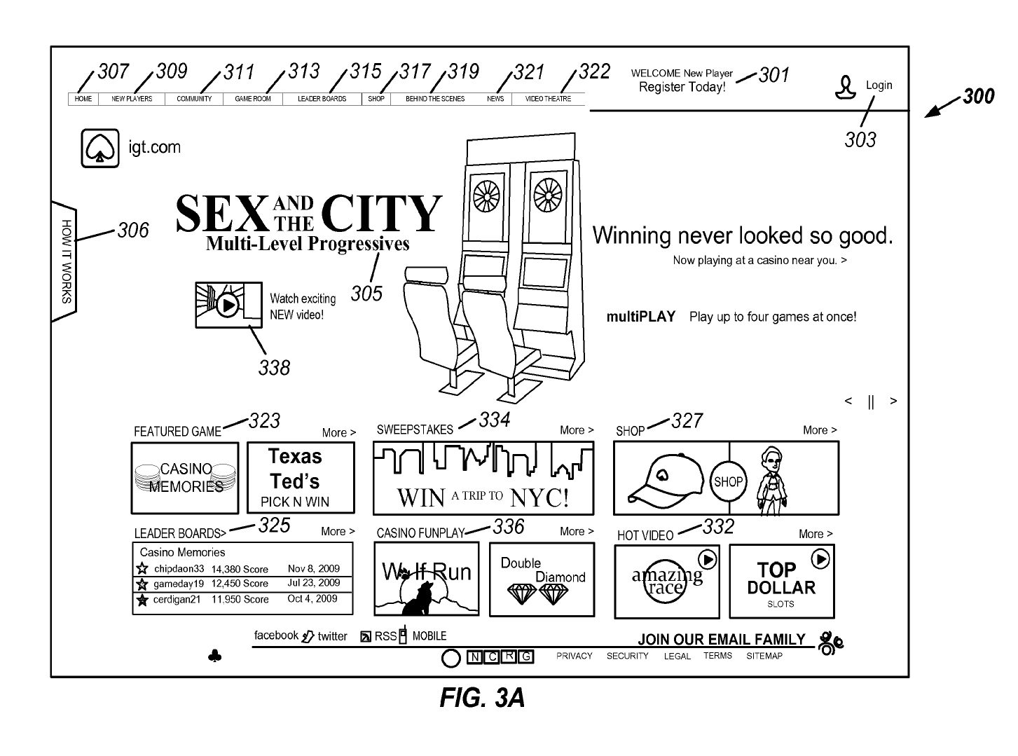

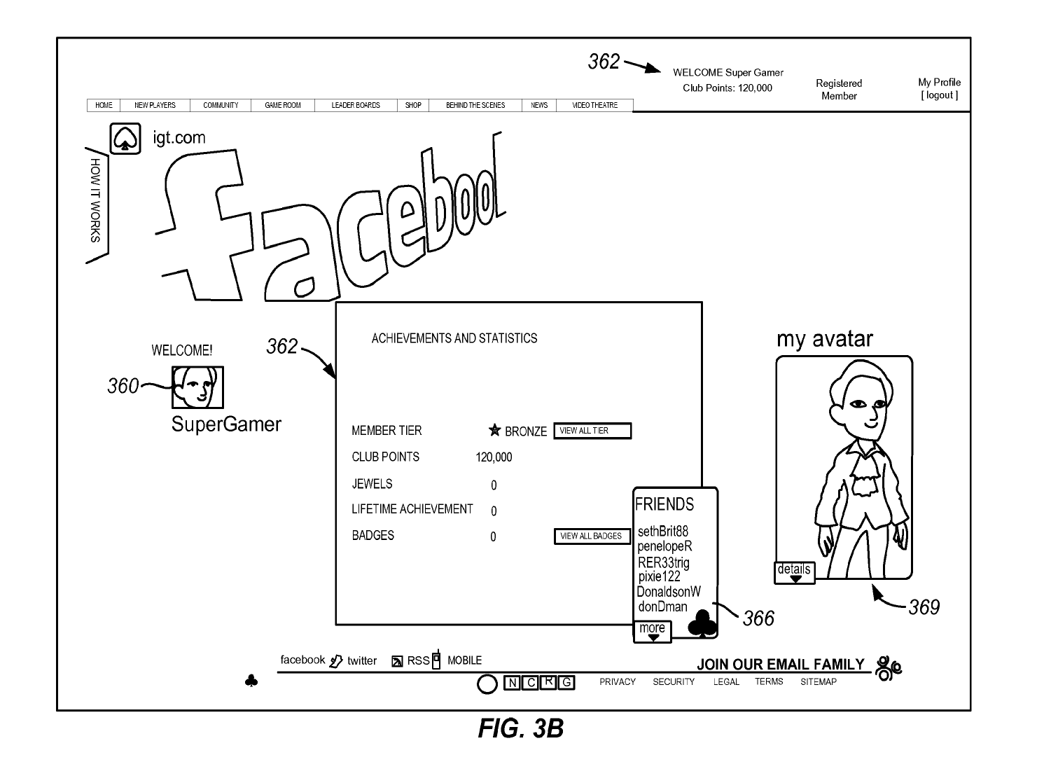

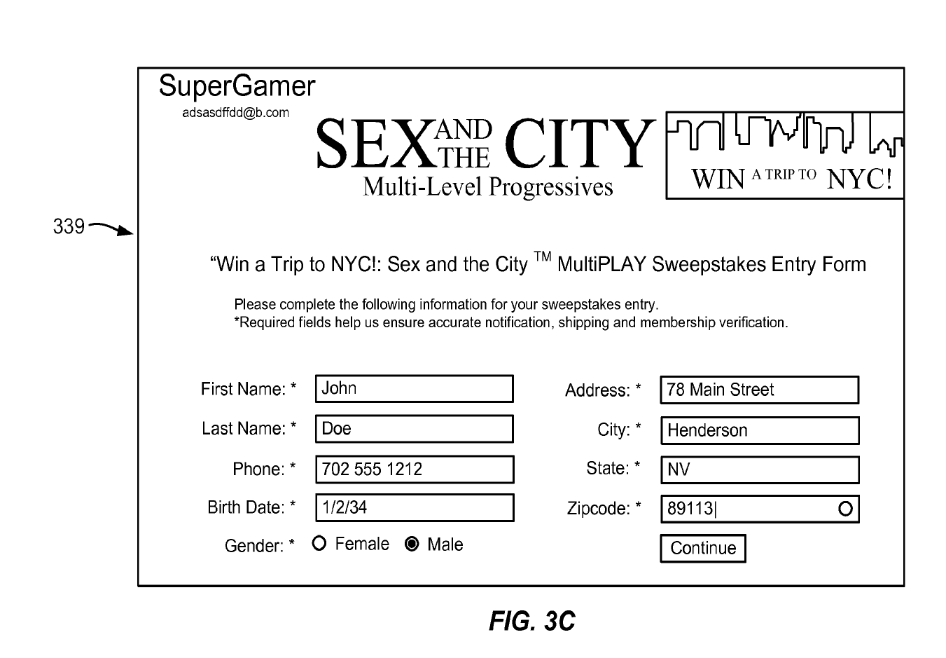

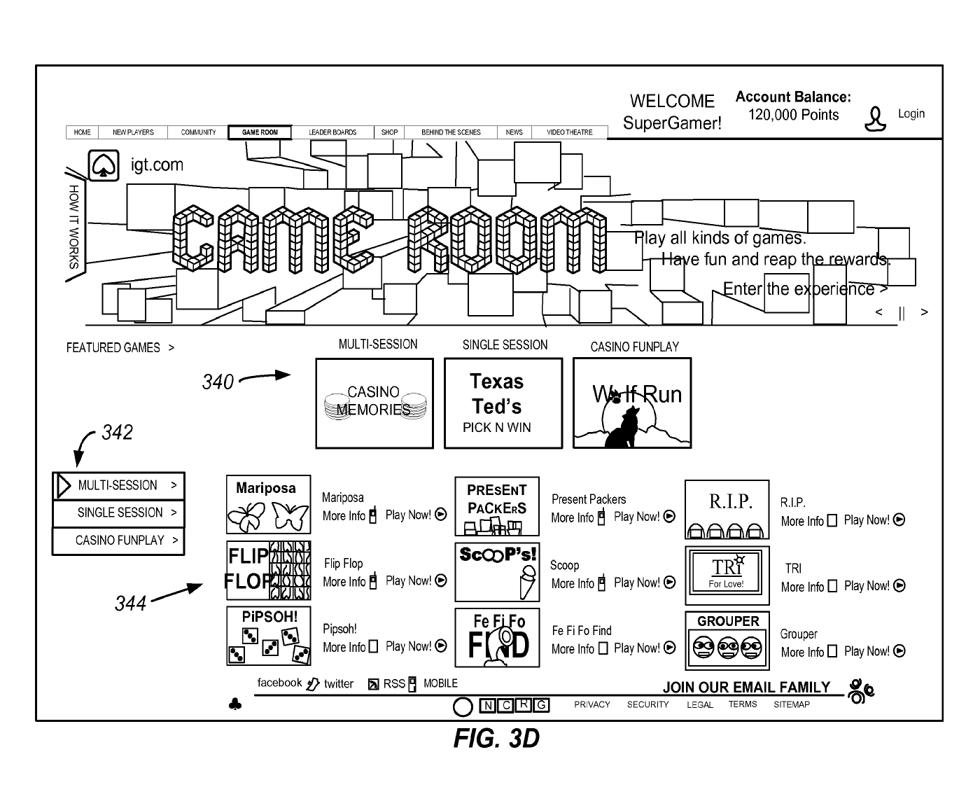

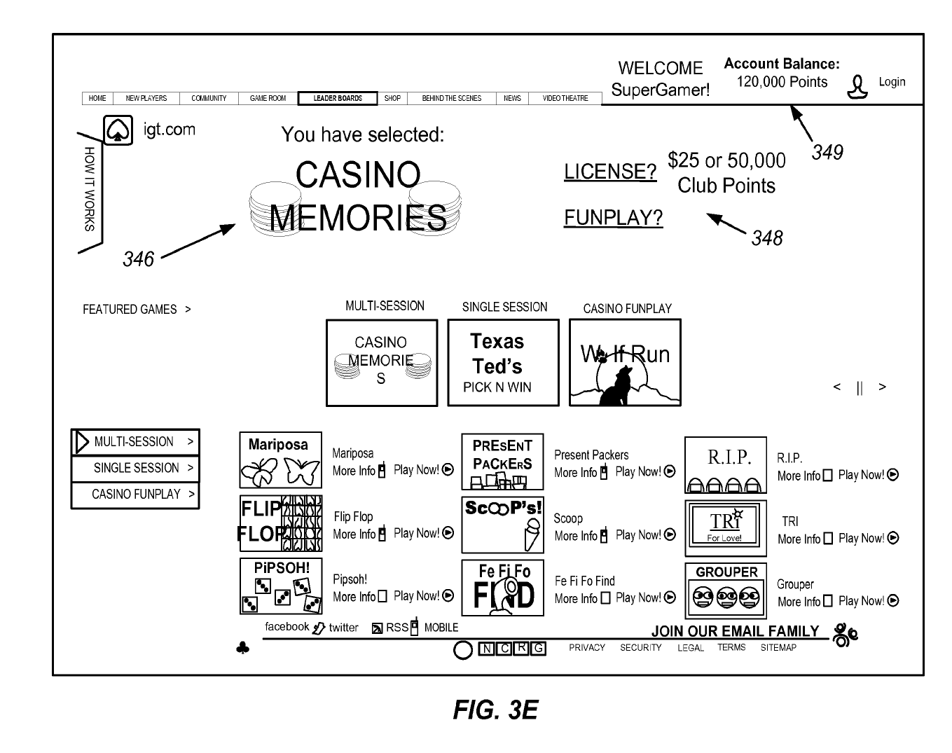

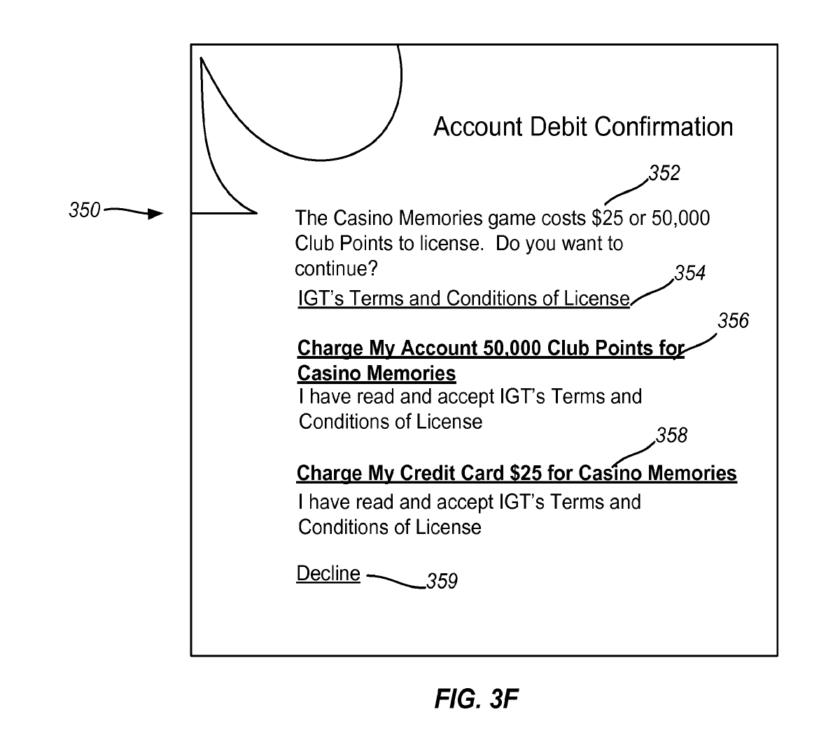

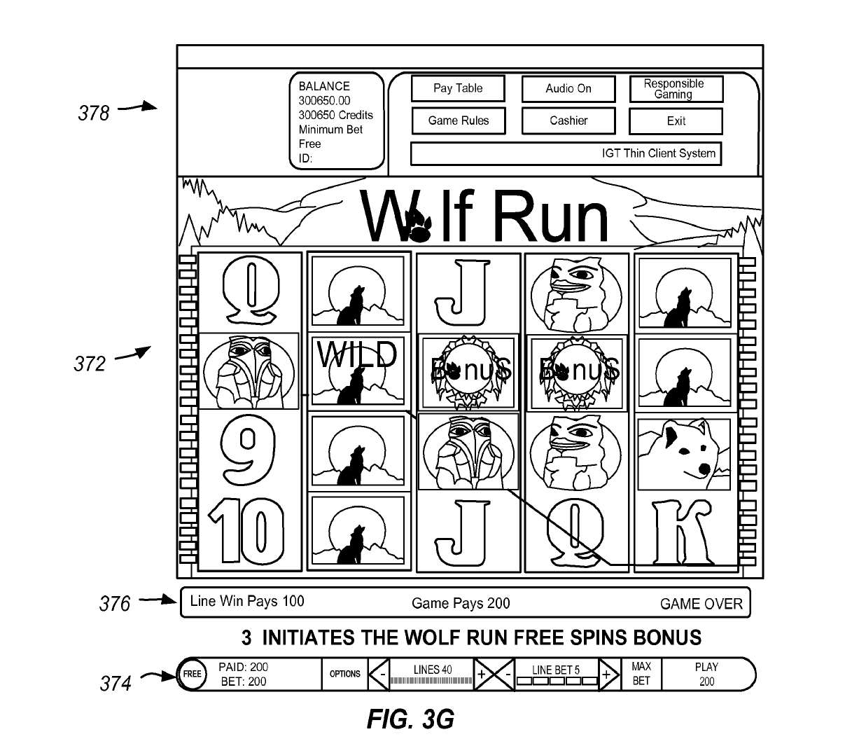

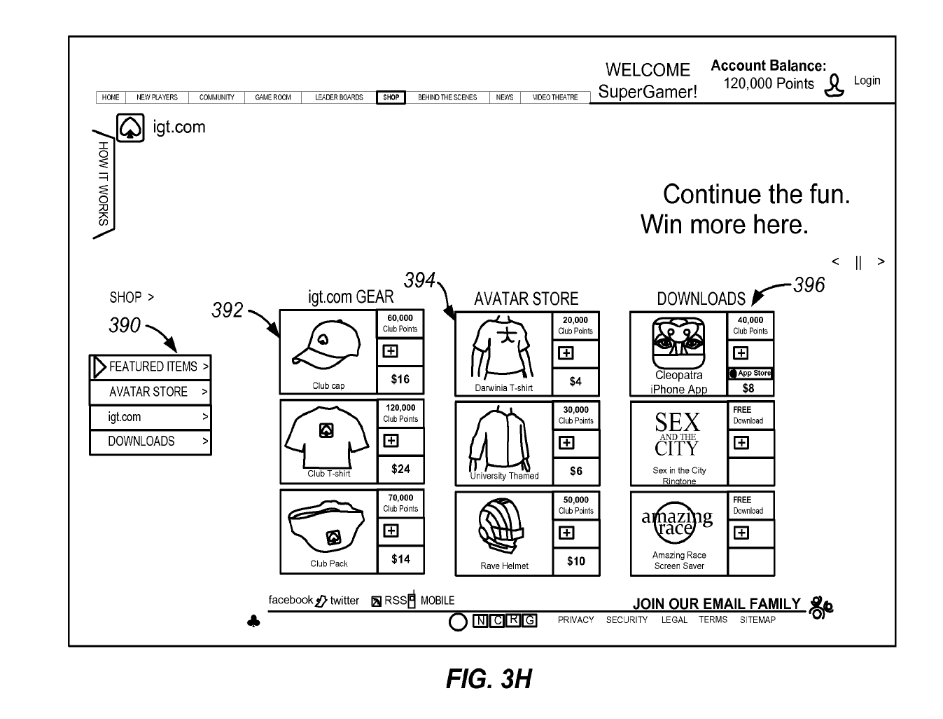

In this example, at least some of web servers 162a may be configured to host the gaming manufacturer's website referenced in FIG. 1 and elsewhere herein. Some examples of web pages that may be presented by web servers 162a are illustrated in FIGS. 3A through 3H and are described below. Public/private key server 162b may provide encryption functionality and certificate server 162c may provide authentication functionality. License servers 162d may license wagering game software to players and/or to casinos.

File servers 162e may provide information regarding casinos and/or players. For example, file servers 162e may provide information regarding player loyalty accounts, player website activity and/or player game licensing accounts. In some implementations, players may be required to establish a player loyalty account in order to license wager gaming software. File servers 162e may also provide information regarding casinos at which players have used wager gaming software, “leader board” information regarding player scores or other gaming activity, information regarding casino accounts with the gaming manufacturer, etc. In some implementations, file servers 162e may also provide gaming software and/or related software, as described elsewhere herein.

E-commerce server(s) 162f may provide functionality relating to secure online payment, player identification, validation, merchandise sales, coordination of merchandise shipping, etc. Storage devices 164 may be configured as primary and/or redundant storage devices, or in any convenient manner. Central system 163 may also use network storage (not shown) in other locations.

Email server(s) 162 may enable email communications between the outside world and various devices used by central system personnel 165, such as workstations 167, laptops 170, desktop computers 172 and other devices that are not illustrated in FIG. 1. For example, some personnel 165 may have wireless devices such as smart phones, notebook computers, etc. Such devices may enable text messaging, Twitter® and/or other modes of communication, including but not limited to communication via social networking software. In this example, personnel 165 may also be contacted by telephones 169.

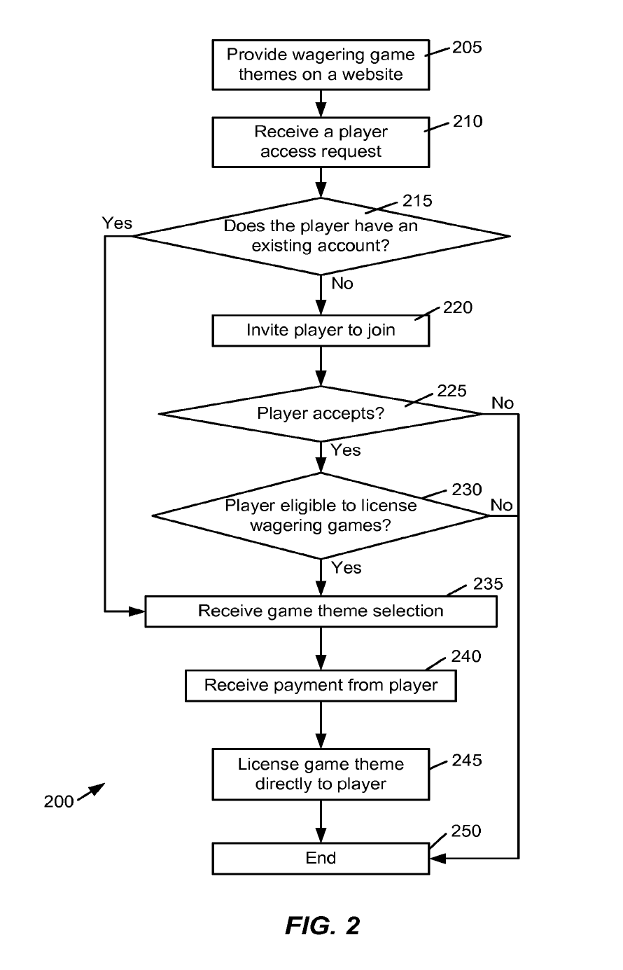

Method 200 will now be described with reference to the flow chart depicted in FIG. 2. The steps of the method(s) shown and described herein, including but not limited to the steps of method 200, are not necessarily performed in the order indicated. Moreover, such methods may include more or fewer steps than are indicated.

In method 200, a gaming manufacturer makes wagering game themes and/or related software applications available on a website associated with the gaming manufacturer. (Step 205.) The website may be hosted by one or more web servers operated by, or operated under the control of, the gaming manufacturer. For example, the website may be hosted by one or more of web servers 162a.

The game themes may have been developed by the gaming manufacturer or by a third-party game developer associated with the gaming manufacturer. Accordingly, such games and applications may be from outside development groups, but have preferably been reviewed and approved by the appropriate parties (the gaming manufacturer, the state gaming commission or other relevant regulatory body, etc.). In some embodiments, a third-party game or application may include a premium cost, at least part of which may be passed through as revenue to the third party. Such an arrangement benefits the gaming manufacturer in that the gaming manufacturer may have a larger range of game developers, thus more games and more variety. The third party developers may also receive profits for their games and may be awarded for their games' true value, according to the actual popularity of each game. Therefore, according to some such implementations, neither the gaming manufacturer nor the casino would need to take the risk of paying for a game that players do not like, whereas the third-party game developers may be rewarded for successful games that players demand.

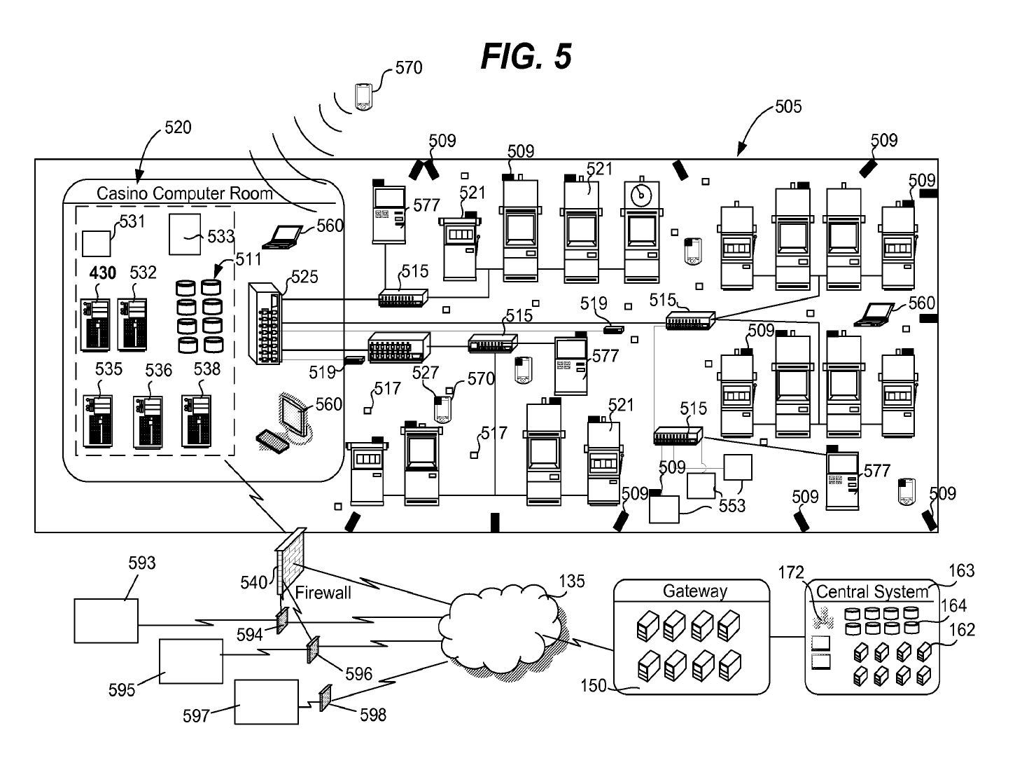

In step 210, a player access request is received. For example, one of players 105 depicted in FIG. 1 may use an associated device to access the gaming manufacturer's website hosted by one of web servers 162a. Examples of such web pages will be described below with reference to FIGS. 3A through 3H. Alternatively, a player may access the gaming manufacturer's website from a device within a casino, such as a networked electronic gaming machine, a kiosk, a mobile device (which may be the player's device or a mobile device provided by the casino), a designated workstation or another such device. Examples of some such devices are provided in FIG. 5 and are described below.

In step 215, it is determined whether the player has an existing account, such as a player loyalty account. For example, the player may be asked to log in, supply a password and/or otherwise verify the player's identity. Here, the player loyalty account may be associated with the gaming manufacturer and not necessarily with a particular casino. Accordingly, such information may be verified by one or more devices of central system 163, e.g., by server 162c.

Having a direct relationship between players and the gaming manufacturer has many potential advantages. Such a relationship allows gaming software to be licensed directly to a player. Instead of instilling loyalty only towards a particular casino, a direct relationship between players and the gaming manufacturer may create and develop player loyalty towards the gaming manufacturer and with games, products and services provided by the gaming manufacturer. Moreover, having a direct relationship between players and the gaming manufacturer allows the gaming manufacturer direct access to player preference information, including but not limited to wagering game preference information, which might otherwise be known only by a casino. Other potential benefits will be described below.

If the player does not have an existing account, the player may be invited to join the player loyalty program. (Step 220.) In some implementations, as here, the player's options may be limited if it is determined (step 225) that the player does not accept an offer to join the player loyalty program. Although method 200 indicates that the next step for such a player is ending step 250, this is merely an indication that a player will not be able to license game themes if the player does not join. The player may, and preferably would, be able to browse through various web pages, investigate and assess the items of interest on the website, etc. In some embodiments, the player may even be able to evaluate wagering games and/or purchase merchandise via the website without becoming a member of the gaming manufacturer's player loyalty program.

If the player accepts an invitation to join the player loyalty program, it will be determined whether the player is eligible to license wagering games. (Step 230.) Such a determination may be made, at least in part, by one or more of servers 162 of central system 163. Such a process may, for example, involve determining a player's identity, age, credit score and/or credit card fraud risk, place of residence, geographical location and/or other criteria. In order to prove identity, the player may be required to provide some form of biometric data in some embodiments.

The determination of step 230 may involve determining whether the player is eligible to play wagering games in at least one jurisdiction of interest. For example, step 230 may involve determining the player's age and comparing the player's age with a jurisdiction's age requirements for wager gaming and/or wager game licensing. If there are participating casinos in the State of Nevada and the player lives in or near Nevada, it may be determined whether the player is eligible to play wagering games approved for play in Nevada. However, in some embodiments, players may license wagering games for wager gaming in states or countries other than that of the player's residence. For example, a player may desire to license wagering games approved for play in one or more states that the player plans to visit, whether or not those states are near the player's state of residence. If participating casinos are located in jurisdictions having different criteria for player eligibility, a player's license may be specific to those jurisdictions, if any, in which the player is eligible to play wagering games. Moreover, some embodiments may involve a separate charge for each jurisdiction.

In some implementations, the process of step 230 may involve performing one or more verification checks for the player. For each such verification check, data regarding the player may be requested from one or more data providers, such as Aristotle's VerifyME™ application, CyberSource's™ Internet Fraud Screen™ application, Experian's™ E-identity™ application, Quova's™ GeoPoint™ application, etc. The process of step 230 may involve calculating a score based on data received from the data provider(s) and determining, based at least in part on the score, whether to allow the player to license wagering games directly from the gaming manufacturer.

However, in alternative implementations, the process of step 230 may be simpler. For example, if the player can provide satisfactory identification and payment data, such as credit card and driver's license information, the player may be allowed to enroll. The player may even be allowed to license wager gaming software without a detailed verification process. However, the player will preferably not be able to use such wager gaming software without providing sufficient proof of eligibility for wager gaming at a participating wager gaming establishment, such as a casino. In such embodiments, the gaming manufacturer may rely on participating casinos to screen out ineligible players.

In this example, if the player is determined to be eligible to license wagering games, the player may be presented with various game theme options. As described in more detail below, a player may be presented with one or more views of game graphics, sounds, specifications, etc. The player may be able to test one or more game themes online. Although some such embodiments may involve actual online wager gaming, other embodiments allow a player to play simulated wagering games that do not involve receiving the player's wagers or paying out monetary awards.

If the player selects a desired game theme for direct licensing (step 235), the player will be prompted to make payment for the license in some acceptable form, such as credit card, debit card, PayPal™, points of the gaming manufacturer's player loyalty program or another form of payment. The amount of the required payment may depend on various factors, such as the time duration of the license, the number of times the game theme may be played, whether there are any applicable discounts or promotions, etc. In some implementations, the game manufacturer may offer incentive bonusing to the player to provide an incentive for paying the license fee. For instance, the manufacturer may provide match play or free play (either directly or in cooperation with the participating casino) the first time that a player enables a game they have purchased. Alternatively, or additionally, the gaming manufacturer may provide entries into a drawing, a free tournament, or other incentives for the player to license gaming software.

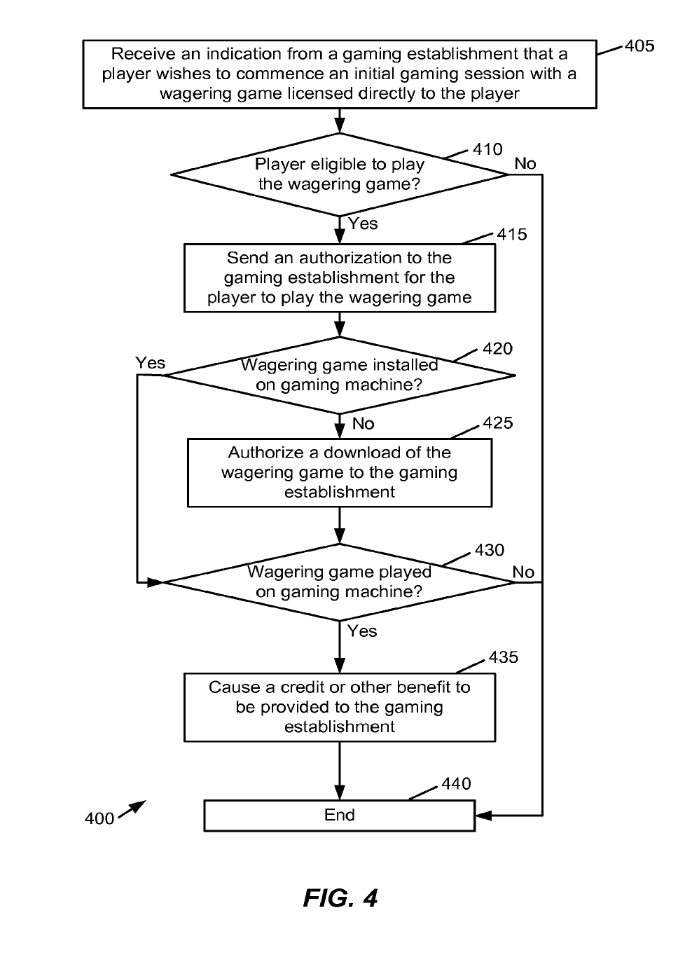

If the player provides the required payment in an acceptable form (step 240) and the payment is verified, the selected game theme may be licensed directly to the player. (Step 245.) The player's account information, licensing information, etc. may be updated accordingly. Relevant information may be stored in one or more storage media associated with central system 163. Use of such licensed game themes will be described below with reference to FIG. 4 et seq.

Referring now to FIG. 3A, an example of a home page 300 for a gaming manufacturer's player website will now be described. The website features shown and described herein are merely examples and should not be considered limiting in any way. Here, a player has accessed home page 300 from an unrecognized source address, so the prompt “WELCOME New Player; Register Today!” is presented in area 301. Clicking on area 301 would cause a registration screen to be presented, allowing the player to become a member of the gaming manufacturer's player loyalty program. Clicking on “Login” area 303 would cause a login screen to be presented, allowing an existing member to log in.

FIG. 3B provides an example of a web page that may be displayed after a player logs in. Here, the player is welcomed and an image corresponding with the player is presented in area 360. In this example, the image is a partial image of the player's avatar. A more complete image of the player's avatar is shown in area 369. Area 362 presents another welcome and a high-level summary of the player's statistics. More details regarding the player's statistics and achievements are set forth in area 364. Area 366 provides a list of, and allows access to information regarding, the player's friends. According to some implementations, when the player interacts with his friends, at least part of his “SuperGamer” avatar and/or related images is presented to his friends, along with text, audio or other data. A player may return to home page 300 by clicking on button 307.

Many other features are presented on home page 300. Here, “Sex and the City” progressive games are advertised in area 305. Still photos and/or videos of these progressives, other games and other website features are presented in various portions of home page 300. In response to a click on tab 306, an explanation of the player loyalty program and other features of the website will be presented. By clicking on area 334, a player may access a web page that provides a sweepstakes entry form relating to a promotion of the “Sex and the City” progressive games. Area 339 of the web page depicted in FIG. 3C provides an example of such an entry form.

Returning to FIG. 3A, it may be observed that various navigation buttons are presented at the top of home page 300 and other web pages of this website, allowing for convenient navigation from web page to web page. A web page that presents additional information for new players may be accessed by selecting button 309. Information regarding the player community may be accessed by clicking button 311. Detailed “leader board” information regarding various game themes may be accessed by clicking on button 315. Selected examples of such information are displayed in area 325. Here, area 325 indicates the top three scores for the “Casino Memories” game, along with the player ID, date and player rank (platinum-level, gold-level and bronze-level).

Button 313 provides access to a “game room” web page, from which information regarding various game themes may be accessed. Some featured games are presented in area 323. Examples of games for which free “casino funplay” is available are shown in area 336. In this example, clicking on one of the images for featured games in area 323 or on one of the “casino funplay” games in area 336 also directs a player to the game room web page.

An example of a game room web page is depicted in FIG. 3D. Here, graphics relating to featured games are shown in area 340. In some embodiments, at least some games and/or versions of games may be available only from the gaming manufacturer's website. For example, the particular versions of “Casino Memories,” “Texas Ted's” and/or “Wolf Run” that are featured in area 340 might only be made available to members of the gaming manufacturer's player loyalty program via the gaming manufacturer's website. This exclusivity may enhance a player's sense of “ownership” or personal connection with that particular game theme. The player's sense of personal connection may, in time, extend to the gaming manufacturer in general. The player may, for example, come to personally value not only the financial rewards made available by the gaming manufacturer's player loyalty program, but also the level of personal control, customization of the player's gaming experience, recognition from the player's gaming community and/or “leader boards,” etc., that are provided by the gaming manufacturer's player loyalty program.

Moreover, if some of the player's friends are not members of the gaming manufacturer's player loyalty program, these friends may notice that the player has special access to games, merchandise and/or services that they do not have. In addition to creating a sense of pride of ownership in the player, the friends' observations may induce the friends to view the gaming manufacturer's website and possibly to enroll in the gaming manufacturer's player loyalty program.

Different game categories may be selected by interacting with area 342: here, a player may select multi-session games, single-session games or “casino funplay” games. In this implementation, a player may choose the “casino funplay” category in order to enable online play of such games. This feature may allow a player to evaluate games for possible licensing, before actually paying money for such games.

Graphics representing various games are displayed in area 344. Here, each game has an associated icon that allows a player to obtain more information regarding the game. Each game has another associated icon that a player may select in order to select the game for some form of online game play.

In this example, the player clicks on the “Casino Memories” portion of area 340. In response, the web page depicted in FIG. 3E is presented to the player. Area 346 notes that the player has selected the “Casino Memories” game. Area 348 provides the player with two basic options: the player may either license the game, for the indicated fee, or may try the game out online. Area 349 notes the player's current Club Points balance.

Here, the player chooses to license the “Casino Memories” game and clicks on the “LICENSE?” portion of area 348. In response, the player is presented with confirmation web page 350 depicted in FIG. 3F. Confirmation web page 350 includes prompt 353 indicating the cost in dollars as well as Club Points. Confirmation web page 350 also includes link 354 to another web page that sets forth terms and conditions of the game license. In this example, the player must at least click on link 354 prior to licensing the game software. Moreover, both payment options include an assertion that the player has read and accepted the terms and conditions of the game license. Such terms and conditions may include temporal, geographic and/or other limits on the use of the software. Moreover, the terms and conditions may indicate participating casinos at which the game software may be used.

By selecting area 356, the player may apply club points and purchase the game license. The player may also use some form of monetary payment, such as the credit card option provided in area 358. In some implementations, the player's preferred form(s) of monetary payment may be indicated in an account profile. Alternatively, the player may decline (option 359). In this example, selects area 358 and is charged $25 for the game license.

The player is then returned to the “Game Room” web page in this example. (See FIG. 3D.) The player then decides to click on the “Wolf Run” image of area 340, in order to enjoy free online play of this game. FIG. 3G presents one example of a web page that may be used for this purpose. Area 372 depicts still and video images of slot reels for this game. Area 374 is a graphical user interface that allows the player to select a number of paylines, simulated wager levels, etc.

Areas 376 and 378 provide information about the Wolf Run game, the player's current credit balance, etc. Area 378 provides links to other resources, including game rules pay table information, etc. When the player is finished playing the Wolf Run game, he or she may select the “Exit” button of area 378. The player will then be presented with the “Game Room” web page. A player may return to home page 300 (see FIG. 3A) by clicking on button 307.

In this example, a web page featuring merchandise available online may be accessed either by clicking on “Shop” button 317 or by clicking on area 327, in which examples of available merchandise are presented. An example of such a web page is shown in FIG. 3H. Here, the web page corresponding to a selection of “Featured Items” area 390 is depicted. Area 392 shows images of clothing and other gear that include a logo of the gaming manufacturer. In this example, a player may purchase such gear either with Club Points or with some form of monetary payment. Area 394 provides three examples of items that may be purchased for a player's avatar. Area 396 features three examples of downloads available to a player. Of the three items shown, only the “Cleopatra” iPhone™ app requires payment. A link to the iPhone™ app store is provided for the player's convenience.

Returning again to the home page shown on FIG. 3A, some of the remaining features will now be described. Buttons 319 and 321 provide links to “behind the scenes” and “news” web pages, in which a player may find additional information regarding upcoming game releases, game upgrades, tournaments, promotions, and other topics. By clicking on button 322 or on area 332, video content will be made available to the player. Here, area 332 provides two examples of available video content.

Turning now to FIG. 4, some examples will be discussed regarding the use of gaming software at participating casinos. Method 400 begins after a player has licensed a wagering game, e.g., using one of the methods described above. In step 405, an indication is received that the player wishes to start an initial gaming session in which the gaming software will be used. In some alternative implementations, the indication of step 405 may be that gaming software will be used for online gaming. However, most implementations described herein involve using gaming software licensed directly to a player in a casino or other such gaming establishment.

Accordingly, in this example step 405 involves receiving an indication that the player wishes to begin using the gaming software at a participating casino. Here, the player has not previously used the gaming software at this casino or any other casino. The indication may, for example, be in response to a player's input at a gaming machine 521, kiosk 577, mobile device 570 or another device of a participating casino. (See FIG. 5.) The player may, e.g., use one or more input devices of an electronic wager gaming machine (“EGM”) to provide identification information and/or information relating to the gaming manufacturer's player loyalty club. This information may be input, at least in part, by using a “Service Window” feature or similar feature of an EGM provided by IGT, the current assignee. Alternatively, or additionally, the EGM may read information regarding the player's membership in the gaming manufacturer's player loyalty club from a player loyalty card or a similar device. The indication of step 405 may be received by one or more devices of casino 505 (such as switches 515 and/or network device(s) 525) and forwarded to central system 163. The indication of step 405 may be received by one or more of servers 162 (e.g., certificate server 162c or one of licensing servers 162d).

In step 410, it is determined whether the player is eligible to use the licensed software to play the wagering game at the participating casino. The process of step 410 may involve player identification, a determination of whether the game license is valid and/or other procedures.

In some embodiments, the player may be asked to provide biometric information, such as voice information, a retinal scan, a fingerprint scan, a facial image, etc. Such information may, for example, be obtained via biometric devices associated with one of EGMs 521 or kiosks 577. However, the player identification process may be simpler. The gaming manufacturer may, for example, rely on a login process for the gaming manufacturer's player loyalty account and/or on information read from the player's player loyalty card for player identification purposes. The gaming manufacturer may leave it to the casino to screen out under-age or otherwise ineligible players.

In some implementations, input may be obtained from personnel of the casino, e.g., from one of mobile devices 570, from a cashier's computer or other device, from one of computers 560 of casino computer room 520, etc. For example, a casino employee may verify the identity of a player by checking a driver's license or other identification documents provided by the player, and may then send verification information to the central system that verifies the player's identity. Similarly, one or more of the personnel 165 of central system 163 may be involved in this process. However, the process of step 410 should preferably be primarily or entirely automated in most instances, in order to make the process as fast, convenient and efficient as possible. After the player has been identified, the player's account information may be accessed, e.g., via one or more of file servers 162e, licensing servers 162d, etc.

If it is determined in step 410 that the player is not eligible to use the licensed wagering game software, the process ends. (Step 440.) The player's device may be sent a response indicating that the access request has been denied. The event is preferably logged and saved for future reference.

However, if it is determined in step 410 that the player may use the licensed wagering game software, an authorization is sent to the gaming establishment indicating that the player may use the wagering game software. (Step 415.) In step 420, a determination is made as to whether the wagering game software is locally available. For example, an EGM used by the player may determine whether the desired software is loaded on the EGM itself. Alternatively, the EGM, a device of central system 163, a device of casino computer room 520 or another device may determine whether the desired software has been downloaded to another device of the casino, e.g., to one of the servers of casino computer room 520. If no copy of the desired software has been installed on the EGM, a copy may be downloaded from a device of casino 505, from central system 163 or from another source. (Step 425.)

In step 430, it is determined whether the player actually initiates a gaming session using the gaming software, e.g., within a first predetermined time. If not, the player may be prompted to use the game. For example, the EGM may make an audio and/or visual prompt to the player to start using the gaming software. If the player does not start using the gaming software within a second predetermined time, the process may end. (Step 440.)

However, if it is determined in step 430 that the player does initiate a gaming session using the gaming software within a predetermined time, a credit or other benefit may be provided to the casino by the gaming manufacturer. (Step 435.) In addition to the financial benefits provided to the casino by the player as a result of wagering game play, the gaming manufacturer may, for example, provide a financial rebate to the casino. Such a rebate may be in the form of a reduction in fees that would otherwise be charged to the casino by the gaming manufacturer, such as fees for maintaining a server-based gaming system, MegaJackpot™ fees, etc. Alternatively, or additionally, the gaming manufacturer may provide some degree of free advertising for the casino on the gaming manufacturer's website, special promotions, and/or any other form of monetary credit to the casino, including cash.

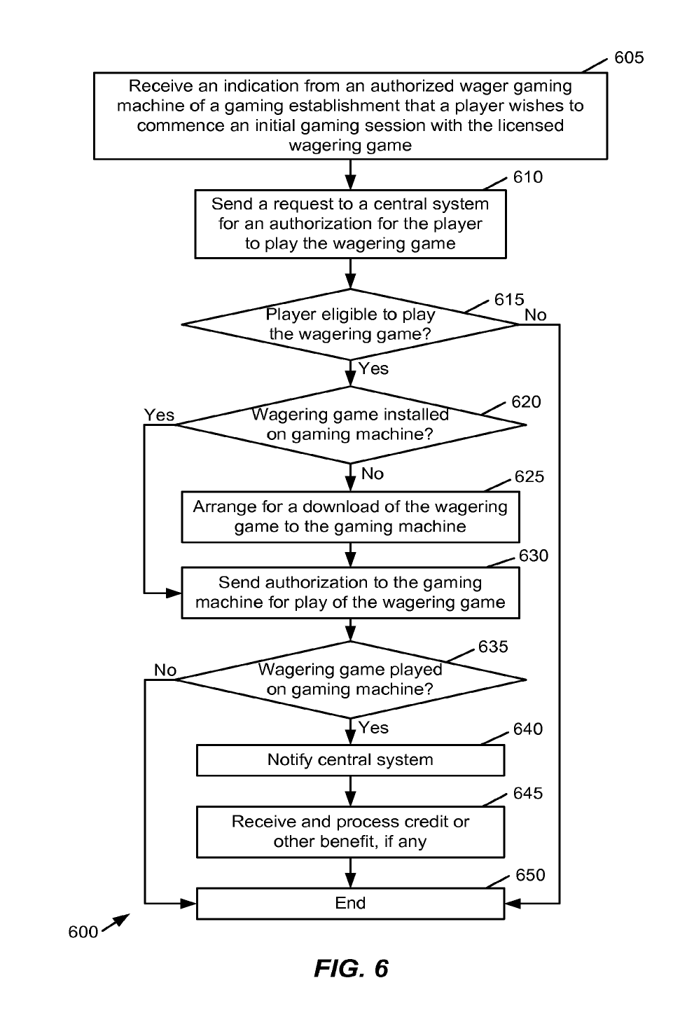

As noted elsewhere herein, the player may also receive a financial or other benefit when the player uses the wager gaming software. For example, the player may be provided a predetermined amount of free play, match play, etc., when they first enable the game at an approved EGM in the casino. In some such implementations, the player may be provided an amount of free play or match play that is greater than or equal to the price that player has paid for licensing the gaming software. Alternatively, or additionally, other incentives for using the wager gaming software may be provided to the player. Such incentives may comprise a free entry in a tournament, a free entry in a drawing or other contest, etc. Some additional examples of benefits that may be provided to a player and/or to participating casinos will be discussed in more detail below with reference to FIG. 6.

Some networks described herein provide methods and devices for managing one or more networked gaming establishments. Such networks may sometimes be referred to herein as server-based gaming networks, Sb™ networks, or the like. Some such gaming networks described herein allow for the convenient provisioning of networked gaming machines and other devices relevant to casino operations. Game themes may be easily and conveniently added or changed, if desired. Related software, including but not limited to player tracking software, peripheral software, etc., may be downloaded to networked gaming machines, mobile gaming devices, thin clients and/or other devices, such as kiosks, networked gaming tables, player stations, etc.

In some implementations, servers or other devices of a central system will determine game outcomes and/or provide other wager gaming functionality. In some such implementations, wagering games may be executed primarily on one or more devices of a central system, such as a server, a host computer, etc. For example, wager gaming determinations (such as interim and final game outcomes, bonuses, etc.) may be made by one or more servers or other networked devices. Player tracking functions, accounting functions and even some display-related functions associated with wagering games may be performed, at least in part, by one or more devices of casino network and/or of a central system.

One example of an Sb™ network is depicted in FIG. 5. Those of skill in the art will realize that this architecture and the related functionality are merely examples and that the present invention encompasses many other such embodiments and methods.

Here, casino computer room 520 and networked devices of a gaming establishment 505 are illustrated. Gaming establishment 505 is configured for communication with central system 563 via gateway 550. Gaming establishments 593 and 595 are also configured for communication with central system 563.

In some implementations, gaming establishments may be configured for communication with one another. In this example, gaming establishments 593 and 595 are configured for communication with casino computer room 520. Such a configuration may allow devices and/or operators in casino 505 to communicate with and/or control devices in other casinos. In some such implementations, a server in computer room 520 may control devices in casino 505 and devices in other gaming establishments. Conversely, devices and/or operators in another gaming establishment may communicate with and/or control devices in casino 505.

For example, a server of casino 505 or central system 563 may be provisioned with relatively more advanced software for patron identification (for example, 3-D facial recognition software, retinal scan or fingerprint analysis software, etc.) than servers of other networked locations. Such a server may process patron identification requests from devices in casino 505 as well as patron identification requests from devices in gaming establishments 593 and 595.

Here, gaming establishment 597 is configured for communication with central system 563, but is not configured for communication with other gaming establishments. Some gaming establishments (not shown) may not be in communication with other gaming establishments or with a central system. Gaming establishment 505 includes multiple gaming machines 521, each of which is part of a bank 510 of gaming machines 521. In this example, gaming establishment 505 also includes a bank of networked gaming tables 553. However, the present invention may be implemented in gaming establishments having any number of gaming machines, gaming tables, etc. It will be appreciated that many gaming establishments include hundreds or even thousands of gaming machines 521 and/or gaming tables 553, not all of which are necessarily included in a bank and some of which may not be connected to a network. At least some of gaming machines 521 and/or mobile devices 570 may be “thin clients” that are configured to perform client-side methods as described elsewhere herein.

Some gaming networks provide features for gaming tables that are similar to those provided for gaming machines, including but not limited to bonusing, player loyalty/player tracking and the use of cashless instruments. Some embodiments can provide automated, multi-player roulette, blackjack, baccarat and/or other table games. The table games may be conducted by a dealer and/or by using some form of automation, which may include an automated roulette wheel, an electronic representation of a dealer, etc. In some such implementations, devices such as cameras, radio frequency identification devices, etc., may be used to identify and/or track playing cards, chips, etc. Some of gaming tables 553 may be configured for communication with individual player terminals (not shown), which may be configured to accept bets, present an electronic representation of a dealer, indicate game outcomes, etc.

Gaming establishment 505 also includes networked kiosks 577. Depending on the implementation, kiosks 577 may be used for various purposes, including but not limited to player identification, cashing out, prize redemption, redeeming points from a player loyalty program, redeeming “cashless” indicia such as bonus tickets, smart cards, etc. In some implementations, kiosks 577 may be used for obtaining information about the gaming establishment, e.g., regarding scheduled events (such as tournaments, entertainment, etc.), regarding a patron's location, etc. Software related to such features may be provided and/or controlled, and related data may be obtained and/or provided, according to the present invention. For example, in some implementations of the invention, kiosks 577 may be configured to receive information from a patron, e.g., by presenting graphical user interfaces.

In some embodiments, kiosks 577 may be configured to provide access to a gaming manufacturer's website, e.g., as described above. Such kiosks 577 may, for example, display advertising regarding the gaming manufacturer's website and entice casino patrons to join the gaming manufacturer's player loyalty club. Current promotions, including but not limited to free play, match play, etc., may be presented on such kiosks 577. Such kiosks 577 may be configured to receive a player's payment via cash, credit card, E-Z Pay™ tickets or other tickets, etc. Some such kiosks 577 may be provided with cameras, finger print scanners, retinal scanners and/or other biometric devices for player identification.

In this example, each bank 510 has a corresponding switch 515, which may be a conventional bank switch in some implementations. Each switch 515 is configured for communication with one or more devices in computer room 520 via main network device 525, which combines switching and routing functionality in this example. Although various communication protocols may be used, some preferred implementations use the Gaming Standards Association's G2S Message Protocol. Other implementations may use IGT's open, Ethernet-based SuperSAS® protocol, which IGT makes available for downloading without charge. Still other protocols, including but not limited to Best of Breed (“BOB”), may be used to implement various aspects of the invention. IGT has also developed a gaming-industry-specific transport layer called CASH that rides on top of TCP/IP and offers additional functionality and security.

Here, gaming establishment 505 also includes an RFID network, implemented in part by RFID switches 519 and multiple RFID readers 517. An RFID network may be used, for example, to track objects (such as mobile gaming devices 570, which include RFID tags 527 in this example), patrons, etc., in the vicinity of gaming establishment 505. Some casinos 505 may provide “smart” player loyalty instruments, such as player tracking cards, which include an RFID tag. Accordingly, the location of such RFID-enabled player loyalty instruments may be tracked via the RFID network. In this example, at least some of mobile devices 570 may include an RFID tag 527, which includes encoded identification information for the mobile device 570. Accordingly, the locations of such tagged mobile devices 570 may be tracked via the RFID network in gaming establishment 505. Other location-detection devices and systems, such as the global positioning system (“GPS”), may be used to monitor the location of people and/or devices in the vicinity of gaming establishment 505 or elsewhere.

Various alternative network topologies can be used to implement different aspects of the invention and/or to accommodate varying numbers of networked devices. For example, gaming establishments with large numbers of gaming machines 521 may require multiple instances of some network devices (e.g., of main network device 525, which combines switching and routing functionality in this example) and/or the inclusion of other network devices not shown in FIG. 5. Some implementations of the invention may include one or more middleware servers disposed between kiosks 577, RFID switches 519 and/or bank switches 515 and one or more devices in computer room 520 (e.g., a corresponding server). Such middleware servers can provide various useful functions, including but not limited to the filtering and/or aggregation of data received from switches, from individual gaming machines and from other devices. Some implementations of the invention include load-balancing methods and devices for managing network traffic.

Storage devices 511, Sb™ server 530, License Manager 531, Arbiter 533, servers 532, 534, 536 and 538, host device(s) 560 and main network device 525 are disposed within computer room 520 of gaming establishment 505. In practice, more or fewer devices may be used. Depending on the implementation, some such devices may reside in gaming establishment 505 or elsewhere.

One or more devices in central system 563 may also be configured to perform, at least in part, tasks specific to the present invention. For example, network device 525, one or more servers 562, arbiter 533, storage devices 564 and/or host devices 560 of central system 563 may be configured to implement some of the functions described in detail elsewhere herein. These functions may include, but are not limited to, the following: (a) enabling communications between EGMs 521 and central system 163; (b) enabling communications between kiosks 577 and central system 163; (c) receiving and processing information regarding credits or other benefits provided by a gaming manufacturer for use of gaming software licensed directly to players who use such software at casino 505; (d) providing free play and/or match play to players who use such software at casino 505; (e) processing reimbursements for such free play and/or match play from a gaming manufacturer; (f) obtaining gaming software from central system 163 that has been licensed directly to one or more players; and (g) providing such gaming software to players for gaming sessions in casino 505.

Other devices that may be deployed in network 505 do not appear in FIG. 5. For example, some gaming networks may include not only various radio frequency identification (“RFID”) readers 517, but also RFID switches, middleware servers, etc., some of which are not depicted in FIG. 5. These features may provide various functions. For example, a server (or another device) may determine a location of a mobile device 570 according to the location of an RFID reader that reads an RFID tag 527.

The servers and other devices indicated in FIG. 5 may be configured for communication with other devices in or outside of gaming establishment 505, such as host devices 560, kiosks 577 and/or mobile devices 570, for implementing some methods described elsewhere herein. Servers (or the like) may facilitate communications with such devices, receive and store patron data, provide appropriate responses, etc., as described elsewhere herein.

Some of these servers may be configured to perform tasks relating to accounting, player loyalty, bonusing/progressives, configuration of gaming machines, etc. One or more such devices may be used to implement a casino management system, such as the IGT Advantage™ Casino System suite of applications, which provides instantaneous information that may be used for decision-making by casino managers. A Radius server and/or a DHCP server may also be configured for communication with the gaming network. Some implementations of the invention provide one or more of these servers in the form of blade servers.

Some preferred embodiments of Sb™ server 530 and the other servers shown in FIG. 5 include (or are at least in communication with) clustered CPUs, redundant storage devices, including backup storage devices, switches, etc. Such storage devices may include a “RAID” (originally redundant array of inexpensive disks, now also known as redundant array of independent disks) array, back-up hard drives and/or tape drives, etc.

In some implementations of the invention, many of these devices (including but not limited to License Manager 531, servers 532, 534, 536 and 538, and main network device 525) are mounted in a single rack with Sb™ server 530. Accordingly, many or all such devices will sometimes be referenced in the aggregate as an “Sb™ server.” However, in alternative implementations, one or more of these devices is in communication with Sb™ server 530 and/or other devices of the network but located elsewhere. For example, some of the devices could be mounted in separate racks within computer room 520 or located elsewhere on the network. Moreover, it can be advantageous to store large volumes of data elsewhere via a storage area network (“SAN”).

Computer room 520 may include one or more operator consoles or other host devices that are configured for communication with other devices within and outside of computer room 520. Such host devices may be provided with software, hardware and/or firmware for implementing various aspects of the invention. However, such host devices need not be located within computer room 520. Wired host devices 560 (which are desktop and laptop computers in this example) and wireless devices 570 (which are PDAs in this example) may be located elsewhere in gaming establishment 505 or at a remote location.

Some additional features of the invention will now be described with reference to FIGS. 5 and 6. Method 600 of FIG. 6 may be performed, at least in part, by one or more devices of casino computer room 520. In step 605, an indication is received from one of gaming machines 521 that a player wants to use gaming software that has been directly licensed to the player. In alternative implementations, the request may be received from one another device, such as one of mobile gaming devices 570 or one of networked gaming tables 553. The indication may include, for example, data identifying the gaming software, data identifying the gaming machine (or other device) on which the software will be used, player identification data and/or data pertaining to the player's account with the gaming manufacturer's player loyalty program.

In step 610, a request is sent to central system 163 to determine whether the player should be authorized to use the gaming software. In this example, the request will include at least some, but not necessarily all, of the data received in step 605. For example, a device in casino computer room 520 that received the indication in step 605 may remove some of the data (e.g., data identifying the gaming machine from which the indication was received), encrypt the data for secure transmission to central system 163, and then send the request to central system 163.

In step 615, a device in casino computer room 520 will receive a response from central system 163 indicating whether to allow the player to use the gaming software. In this example, one or more devices of central system 163 may evaluate various criteria to determine whether to authorize the player the player to use the gaming software. For example, the player's identity may be verified via software for evaluating biometric data. Central system 163 may determine whether the player is actually a member of the gaming manufacturer's player loyalty program and whether the player has a valid license for the gaming software.

Central system 163 may also determine whether the player has previously used the gaming software and/or whether the gaming software may be used at the casino from which the request was received. In some embodiments, after a player has licensed gaming software, the player may be able to use the gaming software on any approved EGM at any approved casino. In other embodiments, the gaming software may only be enabled for a specific casino, a specific group of casinos, etc.

In this example, the response received from central system 163 will indicate not only whether the player is authorized to use the gaming software, but also what financial or other benefit will be provided to the casino and/or to the player if the player actually does use the gaming software. As noted above, the casino may obtain some type of financial benefit from the gaming manufacturer the first time that a player uses gaming software that has been directly licensed from the gaming manufacturer to the player. The player may also obtain a benefit, such as free or match play, the first time that the player such gaming software. If a player has already used the gaming software and has already obtained such benefits, in some implementations the player may be authorized to use the gaming software but the player and/or the casino will not obtain additional benefits.

However, in some implementations, a player may have the option of licensing the same gaming software more than once in order to get additional rewards, bonuses, etc. According to some such implementations, players may be able to earn club points in the gaming manufacturer's player loyalty program for each such additional purchase and may obtain extra incentives, such as additional tournament entries. The gaming manufacturer may adjust the price point for a “re-buy” (such as lowering the price and the incentives). Credits provided to casinos may be adjusted accordingly (e.g., they may be lowered). The gaming manufacturer may enable special features in a re-buy (such as extra game features, extra bonus rounds for the game, special side bets, etc.).

If the message received from central system 163 indicates that the player is not authorized to use the gaming software, the process ends. (Step 650.) In this example, a device of the casino computer room 520 may send an indication to the gaming machine 521 from which an indication was received in step 605 that the player's request to use the gaming software has been denied. Preferably, the device of casino computer room 520 stores a record of this event for future reference.

However, if the message received from central system 163 indicates that the player is authorized to use the gaming software, it is determined in step 620 whether the gaming software is installed on the gaming machine 521 used by the player. The determination of step 620 may be made, for example, by a device of casino computer room 520 or by the gaming machine 521. The gaming software is downloaded, if necessary (step 625), from another device of casino 505 or from central system 163. An authorization is sent to the gaming machine that the desired gaming software may be used. (Step 630.)

In step 635, it is determined whether the gaming software is actually used on the gaming machine (or other device). This process may take place substantially as described above with reference to step 430 of FIG. 4. If the gaming software is used on the gaming machine (or other device), the central system is notified. In this example, central system 163 is notified by a device of the casino computer room 520. Central system 163 responds with an indication of what credit or other benefits should be obtained by casino 505 and/or the player. (Step 645.)

In this example, the player will be provided with some type of benefit because this is the first time that the player has used this gaming software at an approved gaming machine of a participating casino. Here, the player is given $30 in free play or match play. Here, participating casinos may determine whether to provide free play or match play. This information is preferably made available to the player in advance, e.g., via the website and/or prior to the initiation of a wager gaming session at the casino.

In this example, the free or match play is required to be played at that particular gaming machine and is only applicable for wager games using the gaming software that has been licensed directly to the player. For example, the gaming machine 521 on which the player is using the licensed gaming software may receive an instruction from a device of casino computer room 520 indicating that restricted credits be made available to the player, the restricted credits being only applicable for wager games using the licensed gaming software. In some such implementations, the credits may only be made available during the player's first gaming session during which the player uses the licensed gaming software.

In this example, casino 505 also earns a credit or “rebate” from the gaming manufacturer. Thirty dollars of match play will, on average, have a substantially lower real cost to the casino. The actual cost for any one instance will vary, depending on the results of the player's gaming session, but may generally be less than $15. In this example, of the $25 paid by the player to license the game, the gaming manufacturer will rebate a sum of approximately $10 to $15 to the casino and will retain the remaining $10 to $15 as a player fee. Any difference in the real cost to the casino and the cost of the rebate will be due to the casino paying its players and not due to paying the gaming manufacturer.

In some embodiments, the amount of the rebate from the gaming manufacturer to the casino may be variable based on predetermined criteria. For example, the gaming manufacturer may have a “base” rebate of $10 and may add additional funds if the casino is participating in certain programs offered by the gaming manufacturer or has otherwise been identified as a valued customer of the gaming manufacturer. For example, the gaming manufacturer may add an extra $1 to the rebate for casinos that are employing the gaming manufacturer's server-based gaming system. The gaming manufacturer may add an extra $1 if the casino has a predetermined percentage of the casino floor devoted to the gaming manufacturer's wager gaming machines. The gaming manufacturer may add another $1 if the casino is using a predetermined number of the gaming manufacturer's “participation games,” in which a percentage of the revenue from wager gaming is shared with the gaming manufacturer. In this regard, casinos can enhance the rebate to which they are entitled by being better customers of the gaming manufacturer.

Various aspects of the present invention provide a new price model which provides gaming manufacturers with a higher ceiling of possible income, while simultaneously reducing the risk to casinos of implementing new games. At the present time, a new wagering game is considered “good” when a manufacturer is able to sell approximately 1000 units. At an example price point of $2400 per unit, this represents revenues of $2.4 million dollars. In some examples described herein, the gaming manufacturer earns $12 per player purchase, after rebating the casino. At this price point, 200,000 player purchases would be required for a game to be considered good and meet the $2.4 million in revenue. However, the possible upside potential is much higher. At $12 profit per player purchase, revenues can have vast potential if a game becomes an exceptional hit. For instance, if the game were extremely popular among players 1 million licenses were sold, the gaming manufacturer would obtain a revenue of $12 million. Additional revenues could be obtained, e.g., by charging a nominal annual software license fee for connection to the gaming manufacturer's server. In some implementations, such a fee could be recouped from the manufacturer rebate to the casino.

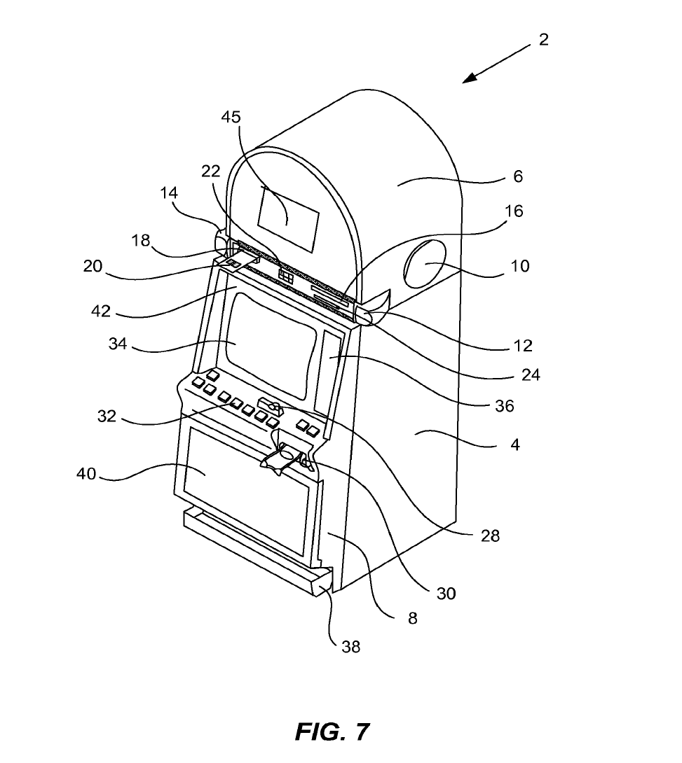

Turning next to FIG. 7, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. Such devices are controlled by what may be referred to herein as a “logic system,” which may include one or more logic devices (such as the master gaming controller, programmable logic devices, graphics processors and other processors, etc.) housed inside the main cabinet 4 of the machine 2.

Many different types of games, including mechanical slot games, video slot games, video poker, video blackjack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in FIG. 7. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by the logic system (e.g., by the master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display-mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

One might imagine that adapting PC technologies to the gaming industry would be a simple proposition, because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces (including but not limited to network interfaces for communication with a casino computer room), security monitoring and trusted memory.

A watchdog timer is normally used in IGT gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as IGT gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 from U.S. patent application Ser. No. 09/925,098, filed Aug. 8, 2001 and titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 7, when a user wishes to play the gaming machine 2, he or she inserts cash through the coin acceptor 28 or bill validator 30. Additionally, the bill validator may accept a printed ticket voucher which may be accepted by the bill validator 30 as an indicium of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions that affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

FIG. 9 is a block diagram of a simplified communication topology between gaming machine 821, network computer 923 and Arbiter 833. Network computer 923 may be, for example, a server or other device within computer room 820 or elsewhere. Although only one gaming machine 821, one network computer 923 and one Arbiter 833 are shown in FIG. 9, it should be understood that the following examples may be applicable to different types of networked devices in addition to gaming machine 821 and network computer 923, and may include different numbers of network computers 923, Arbiters 833 and gaming machines 821. For example, a single Arbiter 833 may be used for secure communications among a plurality of network computers 923 and tens, hundreds or thousands of gaming machines 821. Likewise, multiple Arbiters 833 may be utilized for improved performance and other scalability factors.

Referring to FIG. 9, the Arbiter 833 may include an arbiter controller 921 that may comprise a program memory 922, a microcontroller or microprocessor (MP) 924, a random-access memory (RAM) 926 and an input/output (I/O) circuit 928, all of which may be interconnected via an address/data bus 929. The network computer 923 may also include a controller 931 that may comprise a program memory 932, a microcontroller or microprocessor (MP) 934, a random-access memory (RAM) 936 and an input/output (I/O) circuit 938, all of which may be interconnected via an address/data bus 939. It should be appreciated that although the Arbiter 833 and the network computer 923 are each shown with only one microprocessor 924, 934, the controllers 921, 931 may each include multiple microprocessors 924, 934. Similarly, the memory of the controllers 921, 931 may include multiple RAMs 926, 936 and multiple program memories 922, 932. Although the I/O circuits 928, 938 are each shown as a single block, it should be appreciated that the I/O circuits 928, 938 may include a number of different types of I/O circuits. The RAMs 924, 934 and program memories 922, 932 may be implemented as semiconductor memories, magnetically readable memories, and/or optically readable memories, for example.

Although the program memories 922, 932 are shown in FIG. 9 as read-only memories (ROM) 922, 932, the program memories of the controllers 921, 931 may be a read/write or alterable memory, such as a hard disk. In the event a hard disk is used as a program memory, the address/data buses 929, 939 shown schematically in FIG. 9 may each comprise multiple address/data buses, which may be of different types, and there may be an I/O circuit disposed between the address/data buses.

As shown in FIG. 9, the gaming machine 821 may be operatively coupled to the network computer 923 via the data link 925. The gaming machine 821 may also be operatively coupled to the Arbiter 833 via the data link 949, and the network computer 923 may likewise be operatively coupled to the Arbiter 833 via the data link 947.

Communications between the gaming machine 821 and the network computer 923 may involve different information types of varying levels of sensitivity resulting in varying levels of encryption techniques depending on the sensitivity of the information. For example, communications such as drink orders and statistical information may be considered less sensitive. A drink order or statistical information may remain encrypted, although with moderately secure encryption techniques, such as RC4, resulting in less processing power and less time for encryption. On the other hand, financial information (e.g., account information, winnings, etc.), download information (e.g., game and/or peripheral software, licensing information, etc.) and personal information (e.g., social security number, personal preferences, etc.) may be encrypted with stronger encryption techniques such as DES or 3DES to provide increased security.

As disclosed in further detail in the Arbiter Application, the Arbiter 833 may verify the authenticity of devices in the gaming network, including but not limited to devices sending queries and/or remote procedure calls to gaming machines. The Arbiter 833 may receive a request for a communication session from a network device. For ease of explanation, the requesting network device may be referred to as the client, and the requested network device may be referred to as the host. The client may be any device on the network and the request may be for a communication session with any other network device. The client may specify the host, or the gaming security arbiter may select the host based on the request and based on information about the client and potential hosts. The Arbiter 833 may provide encryption keys (session keys) for the communication session to the client via the secure communication channel. Either the host and/or the session key may be provided in response to the request, or may have been previously provided. The client may contact the host to initiate the communication session. The host may then contact the Arbiter 833 to determine the authenticity of the client. The Arbiter 833 may provide affirmation (or lack thereof) of the authenticity of the client to the host and provide a corresponding session key, in response to which the network devices may initiate the communication session directly with each other using the session keys to encrypt and decrypt messages.

Alternatively, upon receiving a request for a communication session, the Arbiter 833 may contact the host regarding the request and provide corresponding session keys to both the client and the host. The Arbiter 833 may then initiate either the client or the host to begin their communication session. In turn, the client and host may begin the communication session directly with each other using the session keys to encrypt and decrypt messages. An additional explanation of the communication request, communication response and key distribution is provided in the Arbiter Application.

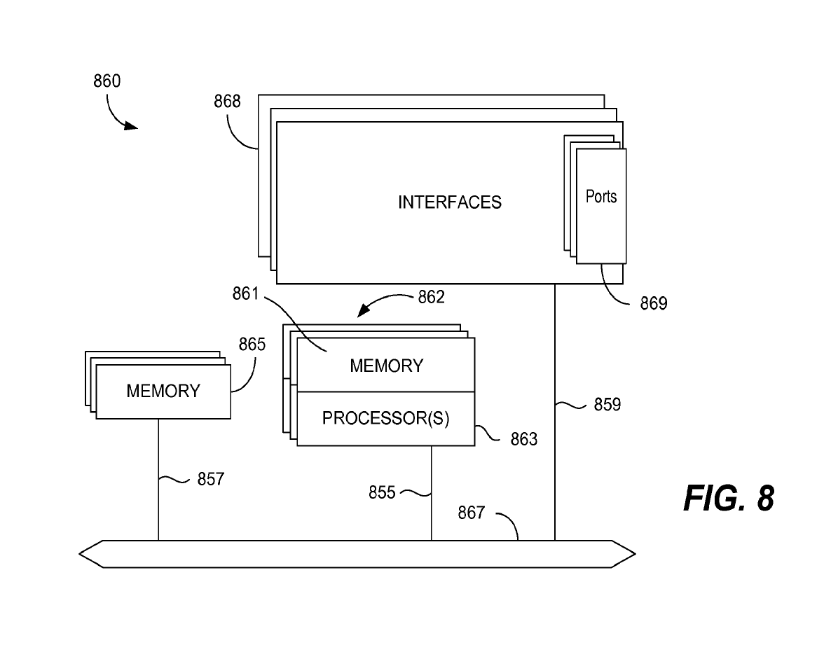

Referring again to FIG. 8, the communication link(s) between casino 805 and central system 863 preferably have ample bandwidth and may, for example, comprise one or more T1 or T3 connections and/or satellite links having comparable bandwidth, etc. Network 829 is the Internet in this example. However, it will be understood by those of skill in the art that network 829 could include any one of various types of networks, such as the public switched telephone network (“PSTN”), a satellite network, a wireless network, a metro optical transport, etc. Accordingly, a variety of protocols may be used for communication on network 829, such as Internet Protocol (“IP”), Fibre Channel (“FC”), FC over IP (“FCIP”), Internet SCSI (“iSCSI,” an IP-based standard for linking data storage devices over a network and transferring data by carrying SCSI commands over IP networks) or Dense Wavelength Division Multiplexing (“DWDM,” an optical technology used to increase bandwidth over existing fiber optic backbones).

If a host device is located in a remote location, security methods and devices (such as firewalls, authentication and/or encryption) should be deployed in order to prevent the unauthorized access of the gaming network.

Similarly, any other connection between gaming network 805 and the outside world should only be made with trusted devices via a secure link, e.g., via a virtual private network (“VPN”) tunnel. For example, the illustrated connection between Sb™ server 830, gateway 850 and central system 863 (that may be used for communications involving peripheral device software downloads, etc.) is advantageously made via a VPN tunnel. Details of VPN methods that may be used with the present invention are described in the reference, “Virtual Private Networks-Technologies and Solutions,” by R. Yueh and T. Strayer, Addison-Wesley, 2001, ISBN#0-201-70209-6, which is incorporated herein by reference and for all purposes. Additionally VPNs may be implemented using a variety of protocols, such as, for example, IP Security (IPSec) Protocol, Layer 2 Tunneling Protocol, Multiprotocol Label Switching (MPLS) Protocol, etc. Details of these protocols, including RFC reports, may be obtained from the VPN Consortium, an industry trade group (VPNC, Santa Cruz, Calif.).

Alternatively, a permanent virtual circuit (“PVC”) can be established to provide a dedicated and secure circuit link between two facilities, e.g., between a casino and central system 863. A PVC is a virtual circuit established for repeated use between the same data terminals. A PVC could be provided, for example, via AT&T's Asynchronous Transfer Mode (“ATM”) switching fabric. Some implementations provide a dedicated line from an endpoint (e.g., from casino 805) into the ATM backbone. Other implementations provide a connection over another network (e.g., the Internet) between an endpoint and the nearest device of the ATM backbone, e.g., to the nearest edge router. In some such implementations, the fixed-sized cells used in the ATM switching fabric may be encapsulated in variable sized packets (such as Internet Protocol or Ethernet packets) for transmission to and from the ATM backbone.

For security purposes, information transmitted to, on or from a gaming establishment may be encrypted. In one implementation, the information may be symmetrically encrypted using a symmetric encryption key, where the symmetric encryption key is asymmetrically encrypted using a private key. The public key may, for example, be obtained from a remote public key server. The encryption algorithm may reside in processor logic stored on the gaming machine. When a remote server receives a message containing the encrypted data, the symmetric encryption key is decrypted with a private key residing on the remote server and the symmetrically encrypted information sent from the gaming machine is decrypted using the symmetric encryption key. A different symmetric encryption key is used for each transaction where the key is randomly generated. Symmetric encryption and decryption is preferably applied to most information because symmetric encryption algorithms tend to be 100-10,000 faster than asymmetric encryption algorithms.

Some network implementations may use Trusted Network Connect (“TNC”), which is an open architecture provided by the Trusted Network Connect Sub Group (“TNC-SG”) of the Trusted Computing Group (TCG). TNC enables network operators to provide endpoint integrity at every network connection, thus enabling interoperability among multi-vendor network endpoints. Alternatively, or additionally, the Secure Internet File Transfer (“SIFT”) may be employed. SIFT allows devices to send and receive data over the Internet in a secure (128-bit encryption) method of transport.

Providing secure connections between devices in a gaming network, such as the connections between the local devices of the gaming network 805 and central system 863, allows for the deployment of many advantageous features. For example, a customer (e.g., an employee of a gaming establishment) may be able to log onto an account of central system 863 to obtain the account information such as the customer's current and prior account status. Automatic updates of a customer's software may also be enabled. For example, central system 863 may notify one or more devices in gaming establishment 805 regarding new products and/or product updates. For example, central system 863 may notify server (or other device) in computer room 820 regarding new software, software updates, the status of current software licenses, etc. Alternatively, such updates could be automatically provided to a server in computer room 820 and downloaded to networked gaming machines.

After the local server receives this information, relevant products of interest may be identified (by the server, by another device or by a human being). If an update or a new software product is desired, it can be downloaded from the central system. Similarly, a customer may choose to renew a software license via a secure connection with central system 863, e.g., in response to a notification that the software license is required.

In addition, providing secure connections between different gaming establishments can enable alternative implementations of the invention. For example, a number of gaming establishments may be owned and/or controlled by the same entity. In such situations, having secure communications between gaming establishments makes it possible for a gaming entity to use one or more servers in a gaming establishment as an interface between central system 863 and gaming machines in multiple gaming establishments. For example, new or updated software may be obtained by a server in one gaming establishment and distributed to gaming machines in that gaming establishment and/or other gaming establishments. A server in one gaming establishment may perform services, such as patron identification services, in response to a request from a device in another gaming establishment.

FIG. 10 illustrates an example of a network device that may be configured for implementing some methods of the present invention. Network device 1060 includes a master central processing unit (CPU) 1062, interfaces 1068, and a bus 1067 (e.g., a PCI bus). Generally, interfaces 1068 include ports 1069 appropriate for communication with the appropriate media. In some embodiments, one or more of interfaces 1068 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1068 control such communications-intensive tasks as encryption, decryption, compression, decompression, packetization, media control and management. By providing separate processors for the communications-intensive tasks, interfaces 1068 allow the master microprocessor 1062 efficiently to perform other functions such as routing computations, network diagnostics, security functions, etc.

The interfaces 1068 are typically provided as interface cards (sometimes referred to as “linecards”). Generally, interfaces 1068 control the sending and receiving of data packets over the network and sometimes support other peripherals used with the network device 1060. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1062 may be responsible for implementing specific functions associated with the functions of a desired network device. According to some embodiments, CPU 1062 accomplishes all these functions under the control of software including an operating system and any appropriate applications software.

CPU 1062 may include one or more processors 1063 such as a processor from the Motorola family of microprocessors or the MIPS family of microprocessors. In an alternative embodiment, processor 1063 is specially designed hardware for controlling the operations of network device 1060. In a specific embodiment, a memory 1061 (such as non-volatile RAM and/or ROM) also forms part of CPU 1062. However, there are many different ways in which memory could be coupled to the system. Memory block 1061 may be used for a variety of purposes such as, for example, caching and/or storing data, programming instructions, etc.

Regardless of network device's configuration, it may employ one or more memories or memory modules (such as, for example, memory block 1065) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 10 illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 10) or switch fabric based (such as a cross-bar).

The above-described devices and materials will be familiar to those of skill in the gaming industry and/or in the computer hardware and software arts. Although many of the components and processes are described above in the singular for convenience, it will be appreciated by one of skill in the art that multiple components and repeated processes can also be used to practice the techniques of the present invention.

Although illustrative embodiments and applications of this invention are shown and described herein, many variations and modifications are possible which remain within the concept, scope, and spirit of the invention, and these variations should become clear after perusal of this application. Accordingly, the present embodiments are to be considered as illustrative and not restrictive, and the invention is not to be limited to the details given herein, but may be modified within the scope and equivalents of the appended claims.

What is claimed is:

1. A method of licensing game themes to players through a gaming system of a game provider, the gaming system including a processor and a memory, the method comprising:
hosting, by the gaming system, a website featuring a library of game themes available for a player to license directly from the game provider, the game themes may be used with authorized wager gaming machines in a participating gaming establishment;
receiving, by the gaming system, a selection of a selected game theme by the player;
determining, by the gaming system, that the player is eligible to play a wager game according to the selected game theme based on player information;
receiving, by the gaming system, a payment for the selection of the game theme;
licensing, by the gaming system, the selected game theme to the player; and
associating, by the gaming system, the selected game theme with a player account of the player.

2. The method of claim 1, further comprising:
receiving an indication from a wager gaming machine at the participating gaming establishment that the player wishes to commence a gaming session of a wagering game in accordance with the selected game theme;
verifying that the player is eligible to play any version of the wagering game at the participating gaming establishment; and
sending an authorization to the gaming establishment, the authorization authorizing the player to play the wagering game according to the selected game theme.

3. The method of claim 2, further comprising authorizing a monetary credit to the gaming establishment.

4. The method of claim 2, further comprising authorizing the gaming establishment to provide free play or match play of the wagering game to the player.

5. The method of claim 2, further comprising sending a download authorization to the wager gaming machine, wherein the download authorization authorizes a download of a compliant version of the selected game theme to the wager gaming machine.

6. The method of claim 5, further comprising determining the compliant version of the selected game theme based on jurisdictional requirements applicable the participating gaming establishment.

7. The method of claim 1, further comprising receiving the player information, wherein the player information includes driver's license information.

8. The method of claim 1, further comprising:
determining that the player is not registered with a loyalty program;
inviting the player to register with the loyalty program; and
registering the player with the loyalty program, including creating the player account.

9. A method of licensing game themes to players through a gaming system of a game provider, the gaming system including a processor and a memory, the method comprising:
hosting, by the gaming system, a website featuring a library of game themes available for a player to license directly from the game provider, the game themes may be used with authorized wager gaming machines in a participating gaming establishment;
receiving, by the gaming system, a selection of a selected game theme by the player;
licensing, by the gaming system, the selected game theme to the player;
associating, by the gaming system, the selected game theme with a player account of the player;
receiving an indication from the participating gaming establishment that the player wishes to commence a gaming session of a wagering game in accordance to the selected game theme;
verifying that the player is eligible to play any version of the wagering game at the participating gaming establishment; and
authorizing the gaming establishment to provide game play of the wagering game according to the selected game theme to the player.

10. The method of claim 9, further comprising authorizing a monetary credit to the gaming establishment.

11. The method of claim 9, further comprising authorizing the gaming establishment to provide free play or match play of the wagering game to the player.

12. The method of claim 9, further comprising:
determining the compliant version of the selected game theme based on jurisdictional requirements applicable the participating gaming establishment; and
sending a download authorization to the wager gaming machine, wherein the download authorization authorizes a download of the compliant version of the selected game theme to the wager gaming machine.

13. A method of licensing game themes to players through a gaming system of a game provider, the gaming system including a website server, a validation server, and a licensing server, the method comprising:
hosting, by the website server, a website featuring a library of game themes available for a player to license directly from the game provider, the game themes may be used with authorized wager gaming machines in a participating gaming establishment;
receiving, by the website server, a selection of a selected game theme by the player;
determining, by the validation server, that the player is eligible to play a wager game according to the selected game theme based on player information;
receiving, by the website server, a payment for the selection of the game theme;
licensing, by licensing server, the selected game theme to the player; and
associating, by the website server, the selected game theme with a player account of the player.

14. The method of claim 13, further comprising:
receiving an indication from a wager gaming machine at the participating gaming establishment that the player wishes to commence a gaming session of a wagering game in accordance with the selected game theme;
verifying that the player is eligible to play any version of the wagering game at the participating gaming establishment; and
sending an authorization to the gaming establishment, the authorization authorizing the player to play the wagering game according to the selected game theme.

15. The method of claim 14, further comprising authorizing a monetary credit to the gaming establishment.

16. The method of claim 14, further comprising authorizing the gaming establishment to provide free play or match play of the wagering game to the player.

17. The method of claim 14, further comprising sending a download authorization to the wager gaming machine, wherein the download authorization authorizes a download of a compliant version of the selected game theme to the wager gaming machine.

18. The method of claim 17, further comprising determining the compliant version of the selected game theme based on jurisdictional requirements applicable the participating gaming establishment.

19. The method of claim 13, further comprising receiving the player information, wherein the player information includes driver's license information.

20. The method of claim 13, further comprising:
determining that the player is not registered with a loyalty program;
inviting the player to register with the loyalty program; and
registering the player with the loyalty program, including creating the player account.
